(19) United States
(12) Patent Application Publication
(10) Pub. No.: US 2015/0256685 A1
(43) Pub. Date: Sep. 10, 2015

(54) SYSTEMS AND METHODS FOR CONTROLLING DURATION OF AN INCOMING CALL NOTIFICATION FOR A MOBILE COMPUTING DEVICE

(71) Applicant: Google Inc., Mountain View, CA (US)

(72) Inventor: Aric Amberden, Long Beach, CA (US)

(73) Assignee: Google Inc., Mountain View, CA (US)

(21) Appl. No.: 14/203,278

(22) Filed: Mar. 10, 2014

(51) Int. Cl. H04M 19/04

(52) U.S. Cl. CPC H04M 19/04

(57) ABSTRACT

Certain implementations of the disclosed technology may include systems, methods, and computer-readable media for controlling duration of an incoming call notification. An example method is provided that can include outputting, by a computing device and for a first period of time, an indication of an incoming call; receiving, by the computing device, during the first period of time, and from one or more sensors, an indication of a movement of the computing device. Responsive to receiving the indication of the movement of the computing device, the method can include continuing to output the indication of the incoming call such that it is output for a second period of time in addition to the first period of time; and extending an answer period for the incoming call such that the incoming call is answerable for the second period of time in addition to the first period of time.

### BACKGROUND

Mobile computing devices, such as smartphones and other portable electronic communication devices, can be configured to output notifications relating to incoming communications. For example, when a phone call arrives, a mobile phone device may output, for a predetermined period, an audible, vibratory, and/or visual notification. In some instances, a user may be alerted by the incoming notification, but may not be able to retrieve her phone in time to answer the call.

### SUMMARY

Some or all of the above needs may be addressed by certain implementations of the disclosed technology. Certain implementations may include systems, methods, and computer-readable media for controlling the duration of an incoming call notification for a mobile computing device.

In one example implementation, a computer-implemented method is provided that can include outputting, by a computing device and for a first period of time, an indication of an incoming call. The method includes receiving, by a processor associated with the computing device, during the first period of time, and from one or more sensors associated with the computing device, an indication of a movement of the computing device; and responsive to receiving the indication of the movement of the computing device, continuing to output the indication of the incoming call such that the indication of the incoming call is output for a second period of time in addition to the first period of time, and extending an answer period for the incoming call such that the incoming call is answerable for the second period of time in addition to the first period of time.

In an example implementation, the computing device may be in communication with a server that can control a when an incoming call is passed to voicemail. For example, and according to an implementation of the disclosed technology, the computing device may send a notification to the server to direct the incoming call to voicemail after a predetermined period in absence of any received or detected indication of interaction with or movement of the computing device.

In one example implementation, a computer-implemented method is provided that can include outputting, by a processor of a user device, for display for a first period of time, an indication of an incoming call. The method includes receiving, by the processor associated with the user device, during the first period of time, and from one or more sensors associated with the user device, an indication of an intent to interact with the user device; and responsive to receiving the indication of the intent to interact with the user device, continuing to output the indication of the incoming call such that the indication of the incoming call is output for a second period of time in addition to the first period of time.

According to another example implementation, a computing system is provided that includes one or more processors, one or more sensors, and memory storing instructions that when executed by the one or more processors cause the computing system to perform operations comprising: outputting, by the one or more processors and for a first period of time, an indication of an incoming call; receiving, by the one or more processors, during the first period of time, and from the one or more sensors, an indication of a movement of the computing system; and responsive to receiving the indication of the movement of the computing system: continuing to output the indication of the incoming call such that the indication of the incoming call is output for a second period of time in addition to the first period of time; and extending an answer period for the incoming call such that the incoming call is answerable for the second period of time in addition to the first period of time.

According to another example implementation, a computer-readable medium is provided for storing instructions, that when executed by a user device having one or more processors, cause the computer device to perform a method. The method can include outputting, by the one or more processors and for a first period of time, an indication of an incoming call; receiving, at the one or more processors, during the first period of time, and from one or more sensors associated with the user device, an indication of an intent to interact with the user device; and responsive to receiving the indication of the intent to interact with the user device; continuing to output the indication of the incoming call such that the indication of the incoming call is output for a second period of time in addition to the first period of time. Certain example embodiments may include extending an answer period for the incoming call such that the incoming call is answerable for the second period of time in addition to the first period of time.

Other implementations, features, and aspects of the disclosed technology are described in detail herein and are considered a part of the claimed disclosed technology. Other implementations, features, and aspects can be understood with reference to the following detailed description, accompanying drawings, and claims.

### BRIEF DESCRIPTION OF THE FIGURES

Reference will now be made to the accompanying figures and flow diagrams, which are not necessarily drawn to scale, and wherein:

FIG. 1 is a block diagram of an illustrative communication system 100, according to an example implementation of the disclosed technology.

FIG. 2 is an illustrative diagram of a user 200 interacting with a computing device 102, according to an example implementation.

FIG. 3 is a block diagram of an illustrative computing system 300, according to an example implementation of the disclosed technology.

FIG. 4 is a flow diagram of a method 400 according to an example implementation.

FIG. 5 is a flow diagram of another method 500 according to an example implementation.

### DETAILED DESCRIPTION

Some implementations of the disclosed technology will be described more fully hereinafter with reference to the accompanying drawings. This disclosed technology may, however, be embodied in many different forms and should not be construed as limited to the implementations set forth herein.

According to an example implementation of the disclosed technology, a time period for answering an incoming call on a mobile computing device (or other communications/computing/phone device) may be extended if the device is moved while it is ringing, for example, to allow time to answer the call. In some instances, when a call arrives, an audible, vibratory, and/or visual notification may be output by the device. The incoming notification may alert a user to the incoming communication, but for various reasons, the user may not be able to retrieve the device in time to answer the call. The device, for example, may be in a position or location that requires extra time to retrieve the device, and/or the user may require additional time to determine who is calling before accepting the call. Such circumstances can result in a missed call.

The term “call,” as used herein, may be any live or synchronous communication, in which any type of data and/or information is transmitted to the communicating parties (including but not limited to voice, data, video, etc.). For example, in one implementation, a call may be a standard device-to-device voice call. In another example implementation, the call may be a video call that can include images of the calling party. In another example implementation, the call may be a “push-to-talk” communication. Other examples of live electronic communications are known in the telecommunications field and may be represented by the term “call” without departing from the scope of the disclosed technology.

Example embodiments of the disclosed technology may assist a user in avoiding missed calls by determining an intent of a user to interact with and/or to retrieve the device. For example, a computing device may utilize one or more sensors associated therewith to sense if the device is moved while it is outputting an indication of an incoming call. In another example implementation, determining an intent to interact with the device may include sensing an audible command. In some implementations, the computing device may extend the duration of the indication of the incoming call based on an intent determined based on the sensed movement (or other signal as indicated below), thus allowing a user sufficient time to either answer or ignore the call.

In certain example implementations, sensors associated with the device may be utilized for detecting one or more physical phenomena related to an interaction (or intent to interact) with a mobile computing/communication device. Such physical phenomena may include, but are not limited to: (1) a movement of the device; (2) movement of people or objects in the vicinity of the device; (3) sounds (such as voice commands, footsteps, or other audible signals that may indicate intent to retrieve the device); (4) changes in light levels that may indicate movement of the device or the movement of people of or objects in the vicinity of the device; and/or (5) a change in a proximity of people or objects in the vicinity of the device. In accordance with an example implementation, one or more sensors, (such as a gyroscope, an accelerometer, a camera, a light sensor, a proximity sensor, a microphone, etc.) may be utilized in sensing one or more of the above-referenced physical phenomena.

In certain example implementations of the disclosed technology, the computing device may provide visible, audible, or vibratory indications that the ring-time extension feature has been activated. For example, in one scenario, a device may alert a user to an incoming call by outputting a visible, audible, or vibratory indication (or combinations thereof) and she may interact with, pick-up, rotate, or otherwise move the device during a first time period to see who is calling. In one example implementation, the interaction with the device may activate the ring-time extension feature, as disclosed herein, for a second time period in addition to the first time period. According to an example implementation of the disclosed technology, the device may output an indication that the ring-time extension feature has been activated.

In one example scenario, the user may wish to silence a ringer of a device while deciding whether to accept an incoming call indicated by the ringer. In one example implementation, the computing device may output, for display, and in response to an incoming call, one or more indications of selectable options or functions for handling the incoming call. In one example implementation, the user may select an appropriate displayed indication, for example to cause the device to mute the ringer while extending the ring-time period without causing the device to pick the call until further input or selection by the user.

In an example implementation, the mobile computing device may be in communication with a server that can control when an incoming call is passed to voicemail. The server, for example, may be associated with a cellular carrier and/or a voicemail service. According to an example implementation of the disclosed technology, the mobile computing device may send a notification to the server to direct the incoming call to voicemail after a predetermined period in absence of any received or detected indication of a movement of the mobile computing device.

In an example implementation, an answerable period (during which a call received at a mobile computing device may be answered before going to voicemail) may be adjusted by the device based on certain communications to an associated cellular carrier and/or a voicemail service.

Certain example implementations may utilize a first portion of the default (or set) ring time as an answerable time that is extendable upon receiving an indication of an intent to interact with the mobile computing device. Certain example implementations may utilize the remainder of the default ring time for the second period of time in which a user may take the call, or let the call go to voicemail.

In one example implementation, the disclosed technology may be utilized to extend the ring-time by sending, by a mobile device, prior to the end of a first ring period, a message to a server instructing the server to allow additional ring time prior to sending the call to voicemail. In another example implementation, the server may be set to an extended ring period and the mobile device may send a message to the server, if no indication of an impending answer is detected, indicating that the call should be sent to voicemail.

Various systems and methods may be utilized for adjusting a call-notification and/or call-answerable time-period, according to example implementations of the disclosed technology, and will now be described with reference to the accompanying figures.

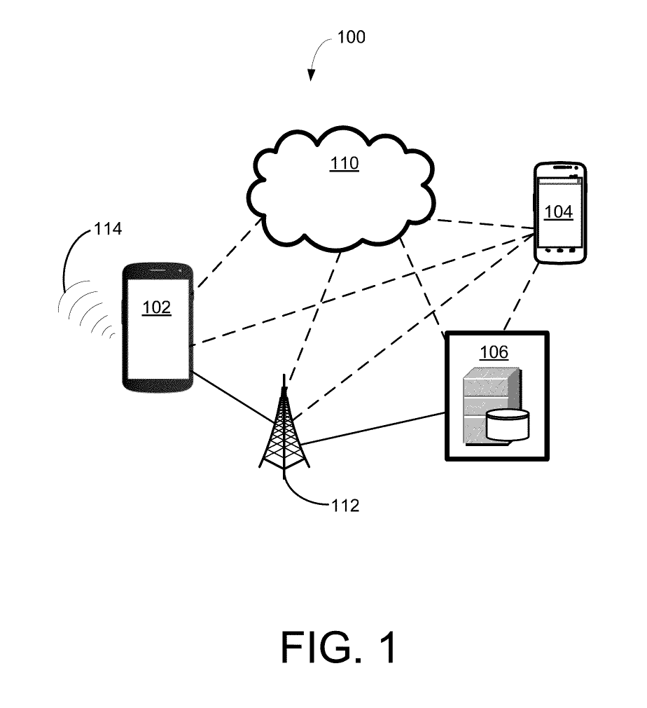

FIG. 1 illustrates an example communication system 100, according to an example implementation of the disclosed technology. In accordance with various example implementations of the disclosed technology, an incoming call notification may be received by a mobile computing device 102. The mobile computing device can be a smartphone, tablet computing device, personal digital assistant (PDA), smart watch, laptop computer, or other portable computing/communications device. In response to receiving the incoming call notification, the mobile computing device 102 may output an indication 114 of the incoming call, for example, to alert the receiving party or user of the incoming call.

According to an example implementation of the disclosed technology, the incoming call may be initiated by a call origination device 104 that, for example, may be a land-line phone or a mobile computing device (such as a smartphone, tablet computing device, PDA, smart watch, laptop computer, or other portable computing/communications device).

Various call routing paths are illustrated in FIG. 1, according to certain example implementations, and may utilize one or more of a server 106, the internet 110, a cellular carrier 112, or various combinations such systems/components in routing the call from the origination device 104 to the destination mobile computing device 102. For example, a call origination device 104 may be utilized to place a call to the destination mobile computing device 102, and the calling process may utilize a typical mobile communications network and equipment associated with one or more cellular carriers 112, as known by those of skill in the art.

In another example implementation, the internet 110 (with appropriate connecting equipment) may be utilized to place a call from the origination device 104 to the destination mobile computing device 102. Other routing paths, and associated equipment, systems, and telecommunication channels beside those depicted in FIG. 1 may be utilized without departing from the scope of the disclosed technology. For example, the incoming call may be received via communication between the originating device 104, a server 106, the Internet 110, and the mobile computing device 102. Certain embodiments may involve a data connection. For example, the data connection may be any of a Wi-Fi, cellular data network, cellular telephone network, LAN, WAN, or other connection. In another implementation, the communication between the server 106 and the mobile computing device 102 may be via a cellular radio channel and through a cellular service provider 112.

In accordance with an example implementation of the disclosed technology, the destination mobile computing device 102 may receive, by a processor associated with the mobile computing device 102, a notification of an incoming call. The mobile computing device 102, in response, and during the first period of time, may output an indication 114 of the incoming call.

According to an example implementation of the disclosed technology, and during the first period of time, the mobile computing device 102 may receive, by one or more sensors associated with the mobile computing device, at least one indication of an intent to interact with the mobile computing device 102. As indicated above, the intent may take the form a one or more physical phenomena such as (but not limited to): (1) a movement of the device; (2) movement of people of or objects in the vicinity of the device; (3) sounds, such as voice commands, footsteps, or other audible signals that may indicate intent to retrieve the device; (4) changes in light levels that may indicate movement of the device or the movement of people of or objects in the vicinity of the device; and/or (5) a change in a proximity of people of or objects in the vicinity of the device.

In accordance with an example implementation of the disclosed technology, and responsive to receiving the indication of intent to interact with the mobile computing device 102, a processor associated with the mobile computing device 102 may continue output the indication 114 of the incoming call such that the indication 114 of the incoming call is output for a second period of time in addition to the first period of time. In accordance with an example implementation of the disclosed technology, and responsive to receiving the indication of intent to interact with the mobile computing device 102, a processor associated with the mobile computing device 102 may extend an answer period for the incoming call such that the incoming call is answerable for the second period of time in addition to the first period of time.

Various implementations in accordance with the disclosed technology may provide for modifying the ringer settings for the mobile computing device 102 based on information associated with the incoming call. According to an implementation, when the mobile computing device 102 has missed a call, a text message may be automatically sent to the caller based on configurable settings. For example, the message may indicate that “I just missed your call and will call you right back.”

According to certain example implementations of the disclosed technology, a maximum duration before a call is forwarded to voice mail may be controlled by the cellular carrier 112. For example, cellular carriers 112 may offer a method to adjust the duration of an incoming call notification before the call is terminated or sent to voicemail without receiving a response to accept the call. One example implementation of the disclosed technology can include setting all calls to have a long ring time (for example, 1 minute, 20 rings, etc.,) via the cellular carrier 112. According to an example implementation of the disclosed technology, and for calls where there is no indication of interaction with mobile computing device 102 in response to the incoming call notification, a processor associated with the mobile computing device 102 may intervene and send the call to voicemail after a duration equal to a first time period (for example, a normal ring notification time). According to an example implementation of the disclosed technology, and for calls where an interaction is detected (such as moving the mobile computing device 102), the processor associated with the mobile computing device 102 may refrain from sending the call to voicemail, and the mobile computing device 102 may continue ringing for a second time period in addition to the first time period.

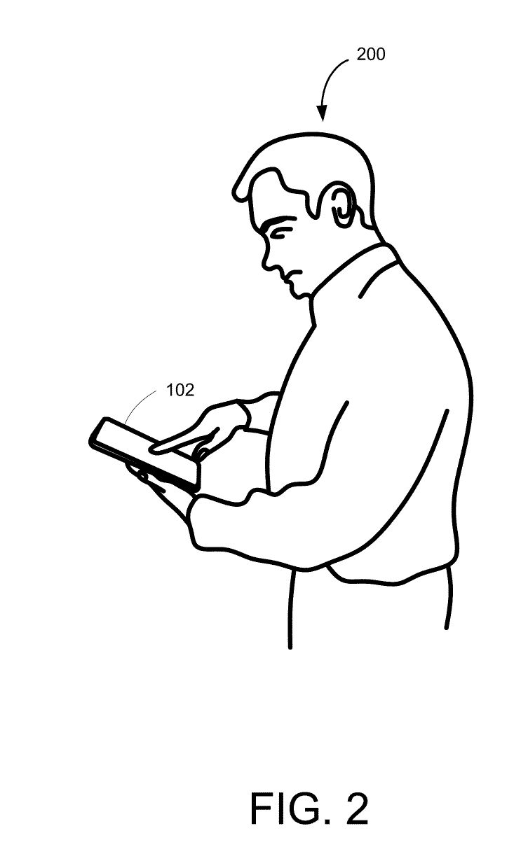

FIG. 2 is an illustrative diagram of a user 200 interacting with mobile computing device 102, according to an example implementation. This illustration depicts a typical scenario where a receiving party interacts with their mobile computing device 102 in response to a received call notification, such as an audible (ring), visual, or vibratory signal indicating a pending call. As indicated above, a finite amount of time is typically required to locate a ringing mobile computing device 102, retrieve it, view the screen, determine the identity of the caller, and respond to (or ignore) the incoming call notification. Example embodiments of the disclosed technology provide systems and methods to extend a notification and answerable period of time when the mobile computing device 102 is moved, or otherwise, interacted with during a first period of time. The illustration of FIG. 2 indicates the typical interaction that could be utilized to extend the notification and answerable time period, but as disclosed herein, other types of interaction may be sensed, utilizing one or more sensors on the mobile computing device 102 to detect the interaction with the device.

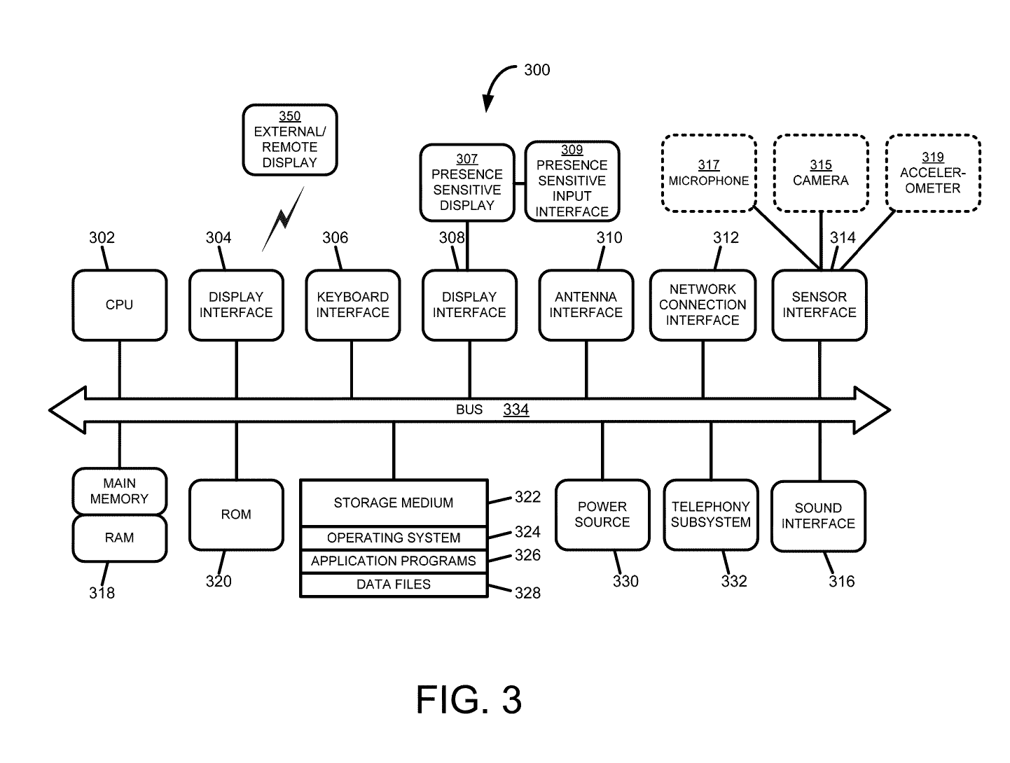

FIG. 3 is a block diagram of an illustrative computing device 300, according to an example implementation of the disclosed technology. Certain aspects of FIG. 3 may be embodied in the mobile device (for example, the mobile device 102 as shown in FIG. 1 and FIG. 2). Various implementations and methods herein may be embodied in non-transitory computer readable media for execution by a processor. It will be understood that the computing device 300 is provided for example purposes only and does not limit the scope of the various implementations of the communication systems and methods.

The computing device 300 of FIG. 3 includes a central processing unit (CPU) 302, where computer instructions are processed; a display interface 304 that acts as a communication interface and provides functions for rendering video, graphics, images, and texts on the display. In certain example implementations of the disclosed technology, the display interface 304 may be directly connected to a local display, such as a touch-screen display associated with a mobile computing device. In another example implementation, the display interface 304 may be configured for providing data, images, and other information for an external/remote display 350 that is not necessarily physically connected to the mobile computing device. For example, a desktop monitor may be utilized for mirroring graphics and other information that is presented on a mobile computing device. In certain example implementations, the display interface 304 may wirelessly communicate, for example, via a Wi-Fi channel or other available network connection interface 312 to the external/remote display 350.

In an example implementation, the network connection interface 312 may be configured as a communication interface and may provide functions for rendering video, graphics, images, text, other information, or any combination thereof on the display. In one example, a communication interface may include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof.

The computing device 300 may include a keyboard interface 306 that provides a communication interface to a keyboard. In one example implementation, the computing device 300 may include a display interface 308 for connecting to a presence-sensitive display 307. In one example implementation, the presence-sensitive display 307 may be in communication with a presence-sensitive input interface 309. According to certain example implementations of the disclosed technology, the display interface 308 may provide a communication interface to various devices such as a pointing device, a touch screen, a depth camera, etc. which may or may not be associated with a display.

The computing device 300 may be configured to use an input device via one or more of input/output interfaces (for example, the keyboard interface 306, the display interface 304, the display interface 308, network connection interface 312, camera interface 314, sound interface 316, etc.,) to allow a user to capture information into the computing device 300. The input device may include a mouse, a trackball, a directional pad, a track pad, a touch-verified track pad, a presence-sensitive track pad, a presence-sensitive display, a scroll wheel, a digital camera, a digital video camera 315, a web camera, a microphone 317, a sensor such as a accelerometer 319 or gyroscope, a smartcard, and the like. Additionally, the input device may be integrated with the computing device 300 or may be a separate device. For example, the input device may be an accelerometer 319, a magnetometer, a digital camera 315, a microphone 317, an optical sensor, etc.

Example implementations of the computing device 300 may include an antenna interface 310 that provides a communication interface to an antenna; a network connection interface 312 that provides a communication interface to a network. As mentioned above, the display interface 304 may be in communication with the network connection interface 312, for example, to provide information for display on a remote display that is not directly connected or attached to the system. In certain implementations, a sensor interface 314 is provided that acts as a communication interface and provides functions for capturing digital images, for example, from a camera 315. In certain implementations, a sound interface 316 is provided as a communication interface for converting sound into electrical signals using a microphone 317 and for converting electrical signals into sound using a speaker. According to example implementations, a random access memory (RAM) 318 is provided, where computer instructions and data may be stored in a volatile memory device for processing by the CPU 302.

According to an example implementation, the computing device 300 includes a read-only memory (ROM) 320 where invariant low-level system code or data for basic system functions such as basic input and output (I/O), startup, or reception of keystrokes from a keyboard are stored in a non-volatile memory device. According to an example implementation, the computing device 300 includes a storage medium 322 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 324, application programs 326 (including, for example, a web browser application, a widget or gadget engine, and or other applications, as necessary) and data files 328 are stored. According to an example implementation, the computing device 300 includes a power source 330 that provides an appropriate alternating current (AC) or direct current (DC) to power components. According to an example implementation, the computing device 300 includes and a telephony subsystem 332 that allows the device 300 to transmit and receive sound over a telephone network. The constituent devices and the CPU 302 communicate with each other over a bus 334.

In accordance with an example implementation, the CPU 302 has appropriate structure to be a computer processor. In one arrangement, the computer CPU 302 may include more than one processing unit. The RAM 318 interfaces with the computer bus 334 to provide quick RAM storage to the CPU 302 during the execution of software programs such as the operating system application programs, and device drivers. More specifically, the CPU 302 loads computer-executable process steps from the storage medium 322 or other media into a field of the RAM 318 in order to execute software programs. Data may be stored in the RAM 318, where the data may be accessed by the computer CPU 302 during execution. In one example configuration, the device 300 includes at least 128 MB of RAM, and 256 MB of flash memory.

The storage medium 322 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow the device 300 to access computer-executable process steps, application programs and the like, stored on removable and non-removable memory media, to off-load data from the device 300 or to upload data onto the device 300. A computer program product, such as one utilizing a communication system may be tangibly embodied in storage medium 322, which may comprise a machine-readable storage medium.

According to one example implementation, the term computing device, as used herein, may be a CPU, or conceptualized as a CPU (for example, the CPU 302 of FIG. 3). In this example implementation, the computing device (CPU) may be coupled, connected, and/or in communication with one or more peripheral devices, such as display. In another example implementation, the term computing device, as used herein, may refer to a mobile computing device, such as a smartphone or tablet computer. In this example embodiment, the computing device may output content to its local display and/or speaker(s). In another example implementation, the computing device may output content to an external display device (e.g., over Wi-Fi) such as a TV or an external computing system.

Various implementations of the communication systems and methods herein may be embodied in non-transitory computer readable media for execution by a processor. An example implementation may be used in an application of a mobile computing device, such as a smartphone or tablet, but other computing devices may also be used, such as to portable computers, tablet PCs, Internet tablets, PDAs, ultra mobile PCs (UMPCs), etc.

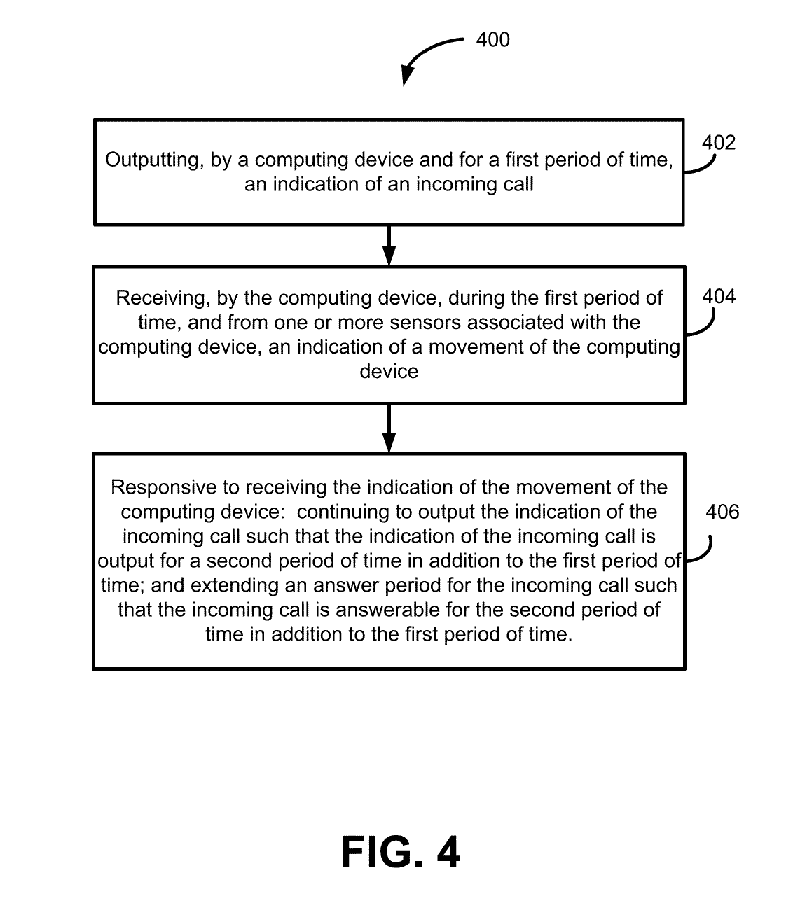

An example method 400 for extending an answerable period for an incoming call will now be described with reference to the flowchart of FIG. 4. The method 400 starts in block 402, and according to an example implementation includes outputting, by a computing device and for a first period of time, an indication of an incoming call. In block 404, the method 400 includes receiving, by the computing device, during the first period of time, and from one or more sensors associated with the computing device, an indication of a movement of the computing device. In block 406, the method 400 includes, responsive to receiving the indication of the movement of the computing device: continuing to output the indication of the incoming call such that the indication of the incoming call is output for a second period of time in addition to the first period of time; and extending an answer period for the incoming call such that the incoming call is answerable for the second period of time in addition to the first period of time.

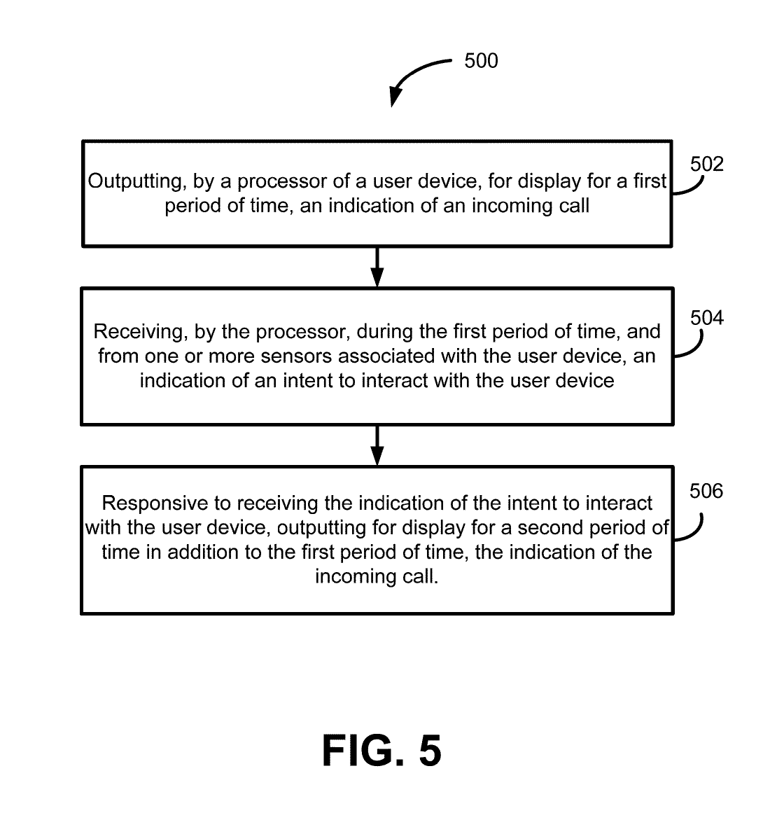

An example method 500 for extending an answerable period for an incoming call will now be described with reference to the flowchart of FIG. 5. The method 500 starts in block 502, and according to an example implementation includes outputting, by a processor of a user device, for display for a first period of time, an indication of an incoming call. In block 504, the method 500 includes receiving, by the processor, during the first period of time, and from one or more sensors associated with the user device, an indication of an intent to interact with the user device. In block 506, the method 500 includes, responsive to receiving the indication of the intent to interact with the user device, outputting for display for a second period of time in addition to the first period of time, the indication of the incoming call.

Certain example implementations may include extending an answer period for the incoming call such that the incoming call is answerable for the second period of time in addition to the first period of time. In one example implementation, extending the answer period for the incoming call may include sending a message from the mobile computing device to a server to request an adjustment of the answer period.

Certain example implementations of the disclosed technology may include ending the indication of the incoming call upon receiving an indication that the call is answered. Certain example implementations can include receiving, by the processor associated with the mobile computing device, during the second period of time, and from one or more sensors associated with the mobile computing device, an indication of a movement of the mobile computing device; and responsive to receiving the indication of the movement of the mobile computing device during the second period of time, sending, from the mobile computing device to a caller associated with the incoming call, a predetermined text response. According to an example implementation of the disclosed technology, incoming call include at least one of voice, data, and video communication. An example implementation can include outputting, by the mobile computing device and for display, caller identification information. In certain example implementations, the caller identification information can include at least one of: a name associated with the caller, information associated with a previous communication with the caller, and calendar information associated with the caller.

According to example implementations, certain technical effects can be provided, such as creating certain systems and methods that help prevent missed calls. Example implementations of the disclosed technology can provide the further technical effects of providing systems and methods for extending a time period for which a call may be answered. Certain technical effects can provide methods for utilizing a default (or preset) ring time such that a first time period in addition to a second time period is less than or equal to the default ring time.

Throughout the specification and claims, numerous specific details are set forth. However, it is to be understood that implementations of the disclosed technology may be practiced without these specific details. In other instances, well-known methods, structures and techniques have not been shown in detail in order not to obscure an understanding of this description. References to “one implementation,” “an implementation,” “example implementation,” “various implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form.

In some instances, a computing device may be referred to as a mobile device, mobile computing device, a mobile station (MS), terminal, cellular phone, cellular handset, personal digital assistant (PDA), smartphone, wireless phone, organizer, handheld computer, desktop computer, laptop computer, tablet computer, set-top box, television, appliance, game device, medical device, display device, or some other like terminology. In other instances, a computing device may be a processor, controller, or a central processing unit (CPU). In yet other instances, a computing device may be a set of hardware components.

Various techniques described herein may be used to detect interactions with a mobile computing device. The various aspects described herein are presented as methods, devices (or apparatus), systems, and articles of manufacture that may include a number of components, elements, members, modules, nodes, peripherals, or the like. Further, these methods, devices, systems, and articles of manufacture may include or not include additional components, elements, members, modules, nodes, peripherals, or the like.

In some instances, a graphical user interface may be referred to as an object-oriented user interface, an application oriented user interface, a web-based user interface, a touch-based user interface, or a virtual keyboard. A presence-sensitive display, as discussed herein, may be a display that accepts input by the proximity of a finger, a stylus, or an object near the display. For example, a user may provide an input to a computing device by touching the surface of a presence-sensitive display using a finger. In another example implementation, a user may provide input to a computing device by gesturing without physically touching any object. For example, a gesture may be received via a video camera or depth camera.

In some instances, a presence-sensitive display can have two main attributes. First, it may enable a user to interact directly with what is displayed, rather than indirectly via a pointer controlled by a mouse or touchpad. Secondly, it may allow a user to interact without requiring any intermediate device that would need to be held in the hand. Such displays may be attached to computers, or to networks as terminals. Such displays may also play a prominent role in the design of digital appliances such as the personal digital assistant (PDA), satellite navigation devices, mobile phones, and video games. Further, such displays may include a capture device and a display.

According to an example implementation of the disclosed technology, the term user device, as used herein, may refer to a mobile computing device, such as a smartphone, mobile station (MS), terminal, cellular phone, cellular handset, personal digital assistant (PDA), smartphone, wireless phone, organizer, handheld computer, desktop computer, laptop computer, tablet computer, set-top box, television, appliance, game device, medical device, display device, or some other like terminology. The user device may include a processor, controller, or a central processing unit (CPU).

According to one example implementation, the terms computing device or mobile computing device, as used herein, may be a CPU, or conceptualized as a CPU (for example, the CPU 302 of FIG. 3). In certain example implementations, the computing device (CPU) may be coupled, connected, and/or in communication with one or more peripheral devices, such as display, navigation system, stereo, entertainment center, Wi-Fi access point, etc. In another example implementation, the term computing device or mobile computing device, as used herein, may refer to a mobile computing device, such as a smartphone, mobile station (MS), terminal, cellular phone, cellular handset, personal digital assistant (PDA), smartphone, wireless phone, organizer, handheld computer, desktop computer, laptop computer, tablet computer, set-top box, television, appliance, game device, medical device, display device, or some other like terminology. In an example embodiment, the mobile computing device may output content to its local display and/or speaker(s). In another example implementation, the mobile computing device may output content to an external display device (e.g., over Wi-Fi) such as a TV or an external computing system.

Furthermore, the various aspects described herein may be implemented using standard programming or engineering techniques to produce software, firmware, hardware, or any combination thereof to control a computing device to implement the disclosed subject matter. The term “article of manufacture” as used herein is intended to encompass a computer program accessible from any computing device, carrier, or media. For example, a computer-readable medium may include: a magnetic storage device such as a hard disk, a floppy disk or a magnetic strip; an optical disk such as a compact disk (CD) or digital versatile disk (DVD); a smart card; and a flash memory device such as a card, stick or key drive. Additionally, it should be appreciated that a carrier wave may be employed to carry computer-readable electronic data including those used in transmitting and receiving electronic data such as electronic mail (e-mail) or in accessing a computer network such as the Internet or a local area network (LAN). Of course, a person of ordinary skill in the art will recognize many modifications may be made to this configuration without departing from the scope or spirit of the claimed subject matter.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

In example implementations of the disclosed technology, the computing device 300 may include any number of hardware and/or software applications that are executed to facilitate any of the operations. In example implementations, one or more I/O interfaces may facilitate communication between the computing device 300 and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the computing device 300. The one or more I/O interfaces may be utilized to receive or collect data and/or user instructions from a wide variety of input devices. Received data may be processed by one or more computer processors as desired in various implementations of the disclosed technology and/or stored in one or more memory devices.

One or more network interfaces may facilitate connection of the computing device 300 inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, etc., for communication with external devices and/or systems.

As desired, implementations of the disclosed technology may include the computing device 300 with more or less of the components illustrated in FIG. 3.

Certain implementations of the disclosed technology are described above with reference to block and flow diagrams of systems and methods and/or computer program products according to example implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, implementations of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology are described above with reference to mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, Internet tablets, PDAs, ultra mobile PCs (UMPCs) and smartphones.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A computer-implemented method comprising:
outputting, by a computing device and for a first period of time, an indication of an incoming call;
receiving, by the computing device, during the first period of time, and from one or more sensors associated with the computing device, an indication of a movement of the computing device; and
responsive to receiving the indication of the movement of the computing device:
continuing to output the indication of the incoming call such that the indication of the incoming call is output for a second period of time in addition to the first period of time; and
extending an answer period for the incoming call such that the incoming call is answerable for the second period of time in addition to the first period of time.

2. The computer implemented method of claim 1, wherein extending the answer period for the incoming call comprises outputting, by the computing device and to a server, a message to adjust the answer period.

3. The computer-implemented method of claim 1, further comprising ending the indication of the incoming call upon receiving an indication that the call was answered.

4. The computer-implemented method of claim 1, further comprising:
receiving, by the computing device, during the second period of time, and from one or more sensors associated with the computing device, an indication of a movement of the computing device; and
responsive to receiving the indication of the movement of the computing device during the second period of time, sending, from the computing device to a caller associated with the incoming call, a predetermined text response.

5. The computer-implemented method of claim 1, wherein the incoming call comprises communication including at least one of voice, data, and video.

6. The computer-implemented method of claim 1, further comprising outputting, by the computing device and for display, caller identification information.

7. The computer-implemented method of claim 6, wherein the caller identification information comprises at least one of: a name associated with the caller, information associated with a previous communication with the caller, and calendar information associated with the caller.

8. The computer-implemented method of claim 1, further comprising: responsive to detecting a conclusion of the first period of time without receiving an indication of movement of the computing device, outputting an indication to send the incoming call to voicemail.

9. A computer-implemented method comprising:
outputting, by a processor of a user device, for display for a first period of time, an indication of an incoming call;
receiving, by the processor, during the first period of time and from one or more sensors associated with the user device, an indication of an intent to interact with the user device; and
responsive to receiving the indication of the intent to interact with the user device, outputting for display for a second period of time in addition to the first period of time, the indication of the incoming call.

10. The computer-implemented method of claim 9, further comprising:
responsive to receiving the indication of the intent to interact with the user device, extending an answer period for the incoming call such that the incoming call is answerable for the second period of time in addition to the first period of time.

11. The computer implemented method of claim 10, wherein extending the answer period for the incoming call comprises outputting, by the user device, and to a server, a message to adjust the answer period.

12. The computer-implemented method of claim 9, further comprising ending the indication of the incoming call upon receiving an indication that the call was answered.

13. The computer-implemented method of claim 9, further comprising:
receiving, by the processor, during the second period of time, and from one or more sensors associated with the user device, an indication of an intent to interact with the user device; and
responsive to receiving the indication of the intent to interact with the user device during the second period of time, sending, from the user device to a caller associated with the incoming call, a predetermined text response.

14. The computer-implemented method of claim 9, wherein the incoming call comprises communication data including at least one of voice, data, and video.

15. The computer-implemented method of claim 9, further comprising outputting, by the processor for display, caller identification information, wherein the caller identification information comprises at least one of: a name associated with the caller, information associated with a previous communication with the caller, and calendar information associated with the caller.

16. A non-transient computer-readable medium storing instructions, that when executed by a user device having one or more processors, cause the one or more processors to perform a method comprising:
outputting, and for a first period of time, an indication of an incoming call;
receiving, during the first period of time, and from one or more sensors associated with the user device, an indication of an intent to interact with the user device; and
responsive to receiving the indication of the intent to interact with the user device, continuing to output the indication of the incoming call such that the indication of the incoming call is output for a second period of time in addition to the first period of time.

17. The non-transient computer-readable medium of claim 16, further comprising extending an answer period for the incoming call such that the incoming call is answerable for the second period of time in addition to the first period of time.

18. The non-transient computer-readable medium of claim 17, wherein extending the answer period for the incoming call comprises outputting, by the user device and to a server, a message to adjust the answer period.

19. The non-transient computer-readable medium of claim 16, further comprising ending the indication of the incoming call upon receiving an indication that the call was answered.

20. The non-transient computer-readable medium of claim 16, further comprising:
Receiving during the second period of time, and from one or more sensors associated with the user device, an indication of a movement of the user device; and
responsive to receiving the indication of the movement of the user device during the second period of time, sending, from the user device to a caller associated with the incoming call, a predetermined text response.

21. The non-transient computer-readable medium of claim 16, wherein the incoming call comprises communication including at least one of voice, data, and video.

22. The non-transient computer-readable medium of claim 16, further comprising: responsive to detecting a conclusion of the first period of time without receiving an indication of movement of the user device, outputting an indication to send the incoming call to voicemail.
